(19) United States
(12) Patent Application Publication
(10) Pub. No.: US 2002/0186189 A1
(43) Pub. Date: Dec. 12, 2002

(54) Method and apparatus for predicting DC offset potential in a liquid crystal display (LCD) device

(76) Inventors: Kevin J. Ilcisin, Beaverton, OR (US); Douglas J. McKnight, Boulder, CO (US)

Correspondence Address: INGRASSIA FISHER & LORENZ, P.C., 7150 E. CAMELBACK, STE. 325, SCOTTSDALE, AZ, 85251, US

(21) Appl. No.: 09/863,212

(22) Filed: May 21, 2001

(51) Int. Cl. G09G 3/36

(52) U.S. Cl. 345/87

(57) ABSTRACT

Methods and apparatus to predict the DC offset potential of a liquid crystal display (LCD) device are described. Surface potential measurements of each half of an LCD device are made before final assembly into the finished LCD device, thereby providing a method of predicting the DC offset potential that will exist in the finished LCD device. The surface potentials of the surfaces that mate with the liquid crystal layer, control the DC offset potential that exists in the finished LCD device.

### CROSS REFERENCES TO RELATED APPLICATIONS

Co-pending, commonly assigned U.S. patent application entitled “Method and Apparatus For Adjusted DC Offset Potential In a Liquid Crystal Display (LCD) Device,” filed the same day as this application, attorney docket number 2789.P046 by Kevin J. Ilcisin and Douglas J. Mc Knight.

### FIELD OF THE INVENTION

The present invention relates to the field of Liquid Crystal Displays (LCDs) and specifically to a method and means for the prediction of the intrinsic direct current (DC) offset that will exist in a finished liquid crystal display (LCD) device.

### BACKGROUND OF THE INVENTION

LCDs describe a broad class of display devices that are used in a variety of applications. Some of the applications are directed to information displays and range from low to high information content. Some examples of low information content displays are watches, calculators, gas pump counters, and portable video games. Some examples of high information content displays are laptop computers, flat panel television screens, video projectors, and head mounted virtual displays.

Although each specific LCD product or application will impose specific constrains on the design, fabrication, and operation of the device, there are fundamental structural components, which are shared by almost all LCD devices. FIG. 1 shows a cross-sectional view of the basic components of a LCD device. LCD device 10 is comprised of liquid crystal (LC) material 7, which is contained, from below, by lower alignment layer 3, which is in contact with lower electrode 2, which is in further contact with lower substrate 1. From above, upper substrate 4 is in contact with upper electrode 5, which contacts upper alignment layer 6. Upper alignment layer 6 is in contact with LC material 7. In the case of high information content displays, the components of LCD device 10 shown in FIG. 1 represent the basic components of a typical single pixel. A typical display is comprised of a plurality of such pixels arranged in either an array or other geometric fashion. The geometry of some of the components, such as the electrodes, may depend on the display of interest, the exact configuration being selected by the device designer. In the following discussions, descriptions of the structure of a LCD device as in FIG. 1 and subsequent figures will be used to described either a display or a pixel interchangeably. When an assembly or device is described in the following sections, it will be understood by one skilled in the art that the device, assembly, layers, and electrodes can be either individual pixels, an entire area of pixels, or the entire display area. Liquid crystals are noted for their anisotropic electrical and optical properties. The optical anisotropy causes birefringence due to the molecular structure and orientation of the LC material. It is known, to those of skill in the art, that the birefringence caused by the optical anisotropy of the LC molecules affects the state of polarization of a polarized light wave passing through the LC layer. Additionally, it is known to those of skill in the art, that when an electric field is applied between the electrodes and across the LC layer, the LC molecules align themselves with respect to the field, the specific orientation depending on the magnitude of the dielectric anisotropy.

Applying a voltage across the LC layer, using the upper and lower electrodes, operates a LCD device. The electrical anisotropy of the LCD material causes a deformation of the LCD material from its equilibrium position, in response to the applied voltage, and can induce the desired modulation of the polarized light passing through the LC layer in cooperation with a suitable analyser. The viewer of the device will see a change in the intensity of the observable light. The degree of modulation and hence the intensity of the light observed by the viewer is typically determined by the amplitude of the voltage placed across the LC layer. For proper operation of a LCD device it is necessary to apply any deforming voltage as a purely AC signal, with no net DC voltage being placed across the LC layer. Neither should there be any intrinsic DC offset existing within the LCD device due to the properties of the device.

Undesirable effects caused by the DC fields are observable to the viewer in the form of flicker, image sticking, and voltage shielding. FIG. 2 shows some of the characteristics of a LCD device with and without an intrinsic DC offset. Characteristics of a prior art LCD device containing a DC offset are shown in 2b. The corresponding characteristics of a LCD device, according to the present invention, are shown in 2a. If a DC voltage is placed across the electrodes of a LCD device, or if a LCD cell has an intrinsic DC offset potential, differences in the observed intensity for the positive and negative polarities of the applied AC waveform will appear. This results in the two curves for observed intensity 15 instead of the single curve for observed intensity 12 which would exist if a DC offset was not present. An asymmetry of the observed light is shown in temporal transmission 16, which will be detected by an observer in the form of undesirable flicker.

It is often necessary to correct for the presence of the DC offset by making changes in the fabrication of the LCD device. The most common way to measure the DC offset is with the finished LCD device. Although this method allows for a statistical determination of the distribution of DC offset for a sample of manufactured devices, there is not a known way to measure parameters of the LCD device during fabrication that can be used to assess the DC offset that can be expected when the LCD device is completed.

Prior art attempts at solving the problem of intrinsic DC offset have not been effective. One such prior art attempt is U.S. Pat. No. 5,764,324, Lu et al., “Flicker-Free Reflective Liquid Crystal Cell,” [Lu] in which it is suggested that DC offset is eliminated by selecting electrodes with similar work functions. The “work function” of the electrode is not the controlling parameter that can be used to eliminate the DC offset in a LCD device and thereby eliminate flicker. Lu does not teach, according to the method of the present invention, that the surface potential of each assembly contacting the LC material governs the DC offset that will exist in the finished LCD device. What is needed is a way to predict the DC offset that will exist in a finished LCD device accounting for the surface potential.

### SUMMARY OF THE INVENTION

In one embodiment, of the present invention, a method for predicting an intrinsic DC offset potential in a liquid crystal display device includes connecting a reference terminal of an electric field measuring device (EFMD) to an electrode from an upper liquid crystal display assembly, placing a measurement probe of the EFMD proximate to a surface of the upper liquid crystal display assembly that will contact a first surface of a liquid crystal layer of the liquid crystal display device when assembled, measuring a surface potential of the surface of the upper liquid crystal display assembly with the EFMD, and repeating the method to obtain a surface potential measurement of a lower liquid crystal display assembly that will contact a second surface of the liquid crystal layer of the liquid crystal display device when assembled, such that when the surface potential of the upper liquid crystal display assembly and the surface potential of the lower liquid crystal display assembly are subtracted, the prediction of the intrinsic DC offset potential is obtained. In a typical embodiment, a non-contacting electrostatic voltmeter may be used to measure the surface potential of the LCD assembly.

In another embodiment, of the present invention, a method of predicting an intrinsic DC offset potential in a liquid crystal display device includes: connecting reference terminals of two EFMDs to electrodes from upper and lower liquid crystal display assemblies; calibrating, zeroing or using two instruments with identical internal standards such that both EFMDs give the same relative potential for measurements of the same substrate, placing measurement probes of the EFMDs proximate to surfaces of the liquid crystal display assemblies that will contact surfaces of a liquid crystal layer of the liquid crystal display device when assembled, measuring surface potentials for the upper and lower assemblies with the EFMDs, and subtracting the surface potentials to obtain a prediction of the intrinsic DC offset potential.

### BRIEF DESCRIPTION OF THE DRAWINGS

The present invention is illustrated by way of example and not is limited in the figures of the accompanying drawings, in which like references indicate similar elements.

FIG. 1 shows a cross-sectional view of the basic components of an LCD.

FIG. 1a shows a basic transparent LCD device.

FIG. 1b shows a basic reflective LCD device.

FIG. 2 shows some of the characteristics of a LCD device with and without intrinsic DC offset.

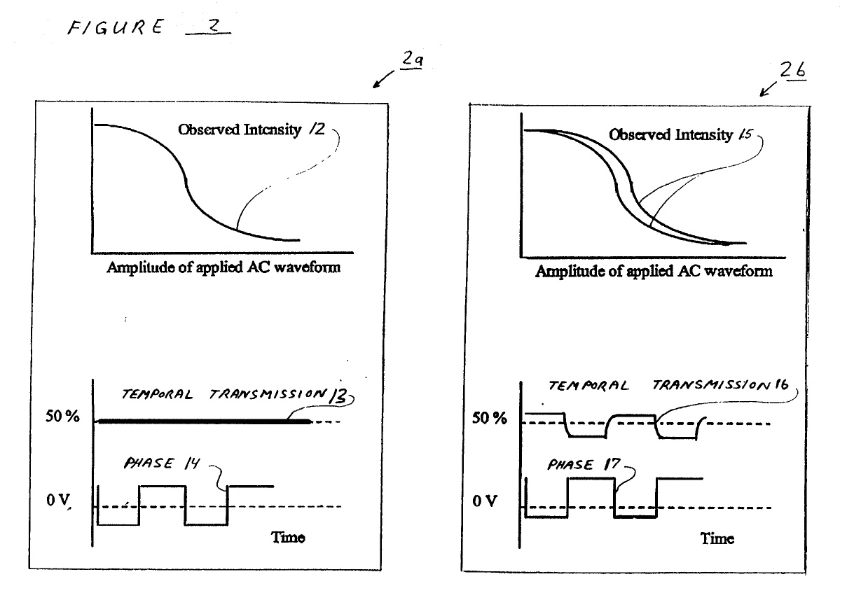

FIG. 3 indicates the upper and lower assemblies of a LCD device and shows where the surface potentials of the assemblies are measured.

FIG. 3a shows the effect of probe head size on the measured surface potential.

FIG. 4 depicts the configuration of the experimental test equipment used to predict the intrinsic DC offset potential in a LCD device.

FIG. 5 is a plot of predicted DC offset potential verses measured DC offset potential in two different LCD devices.

### DETAILED DESCRIPTION

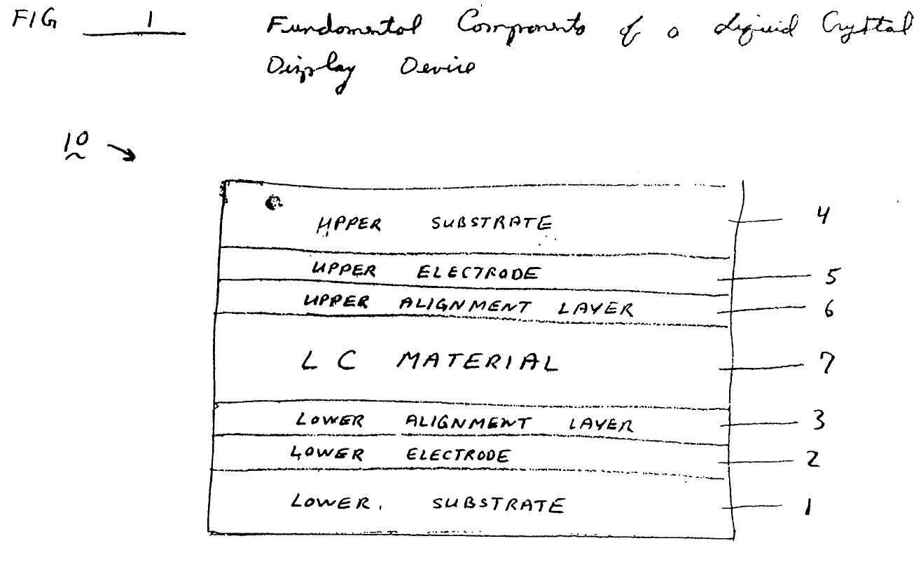

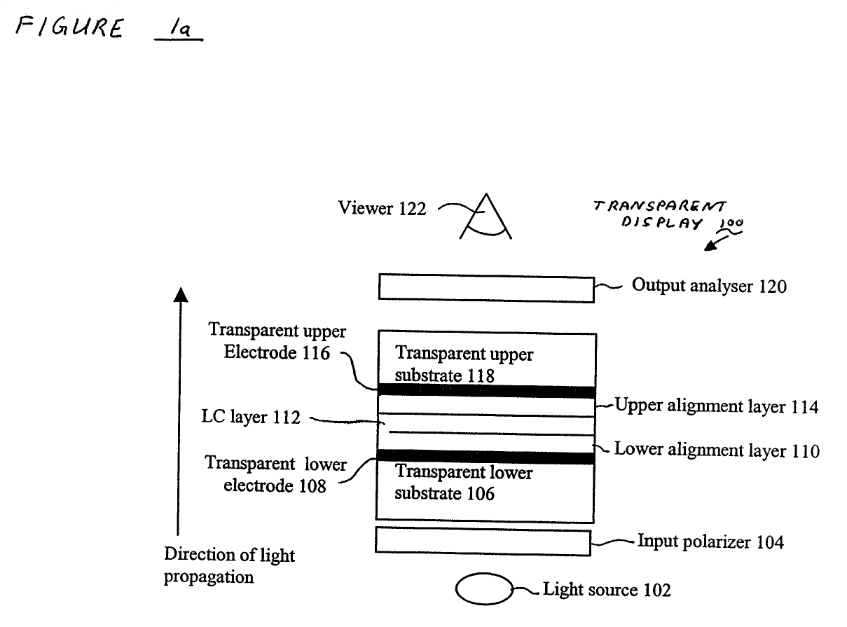

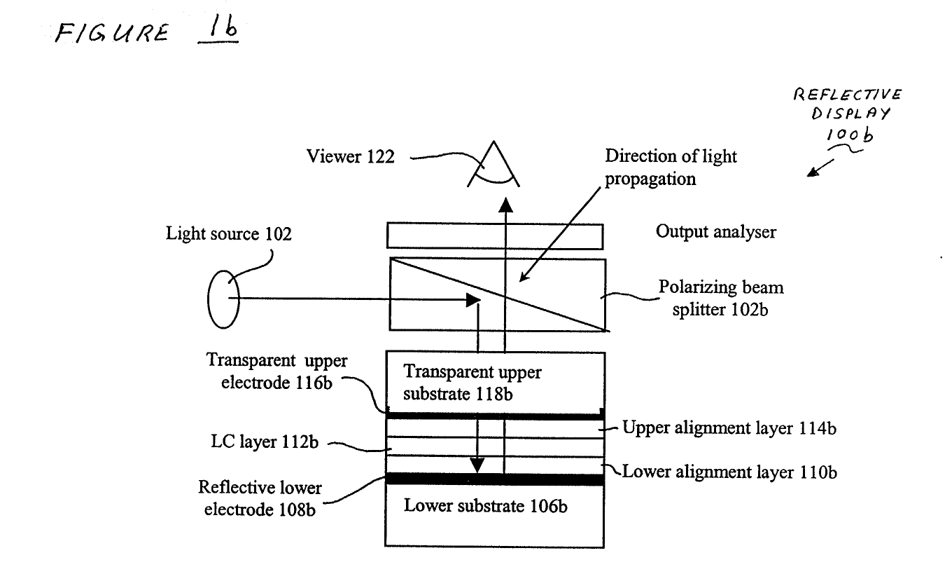

A cross section of a typical LCD device is shown in FIG. 1, where an LCD layer is positioned with adjoining; alignment layers, electrodes, and mechanical substrates.

With reference to FIG. 1, liquid crystal display device 10 may be viewed from above, or observed by looking down through upper substrate 4, in order to see LCD material 7, where information is displayed. Upper substrate 4 may be made of glass or plastic. LCD devices can be classified as transparent or reflective. Depending on the type of display, lower substrate 1 may be transparent, as in a back-lit laptop display, or opaque such as in a reflective display. For reflective displays, lower substrate 1, can also be made from glass, silicon, or any other material that can serve as a suitable support for LC material 7.

An electrode is typically fabricated on each substrate. In between each electrode and LC material is an alignment layer. The alignment layers are typically organic layers which are either treated mechanically or optically to provide the LC material with orientation and anchoring at each end of the LCD device. A typical material for the alignment layers is polyimide, which is commercially available from many suppliers such as NISSAN Chemical, Inc. Thus, lower electrode 2 is connected with lower substrate 1 and lower alignment layer 3. Lower alignment layer 3 is connected with LC material 7. On the upper side of LC material 7, upper substrate 4 is connected with upper electrode 5. Upper electrode 5 is connected with upper alignment layer 6 and upper alignment layer 6 is connected with LC material 7. A LCD device functions by applying a voltage across LC material 7.

There are differences in the typical construction and operation of the cell of a reflective LCD device as compared with the cell of a transparent LCD device. The cell of the LCD device will be considered to include the electrodes and all layers disposed between the electrodes.

With reference to FIG. 1a, the operation of a typical transparent LCD device is described. Unpolarized light is incident from the bottom of transparent display 100, emanating from light source 102. The light first passes through input polarizer 104. Typically, input polarizer 104 is a linear polarizer, and thus the light incident on transparent lower substrate 106 is linearly polarized. The polarized light then propagates through transparent lower substrate 106, which is typically made from glass, but may be made from plastic or other suitable materials, which do not change the polarization state of the light. The polarized light then propagates through transparent lower electrode 108, lower alignment layer 110, and interacts with LC layer 112. After propagating through LC layer 112, the light then passes through transparent upper alignment layer 114, transparent upper electrode 116, and transparent upper substrate 118. The light then passes through output analyzer 120, which is typically a second polarizer and is viewed by viewer 122.

There are many types of LC materials and several LC Electro-optic (EO) effects that can be used for LC layer 112. These include modes such as twisted nematic (TN) and electrically controlled birefringence (ECB). It is important to note that each of the EO effects, in combination with a voltage applied across the LC layer by the electrodes, can be used to change the state of polarization of the light passing through the LC layer. In a typical TN cell, when no voltage is applied, the polarization state of the incident light is rotated by 90 degrees upon propagating through the cell. When the maximum voltage is applied, no change in the polarization state occurs.

In the example of a TN cell, analyser 120 would be a second linear polarizer. The orientation of this polarizer depends on the LC material used and the choice of the display mode. For example, in a typical normally white TN cell, output analyser 120 would be oriented with its polarization axis rotated 90 degrees with respect to the orientation of input polarizer 104. Thus, with no voltage applied to a TN cell, the input light is rotated 90 degrees on passing through the cell and then is transmitted through output analyser 120 with little additional attenuation. Viewer 122 sees a bright or “on” display. If a voltage is applied to the cell, the incident light is not rotated by the TN cell, and the light is then absorbed by output analyser 120 and the viewer sees a dark, “off”, or black display.

There are differences in the typical construction and operation of the cells for reflective and transparent LCD devices, as was previously mentioned. With reference to FIG. 1b, the operation of a typical reflective LCD device is described. Light is incident from the side of reflective display 100b, emanating from light source 102. The light passes through an input polarizer. For the display shown in FIG. 1b, the input polarizer is shown as polarizing beam splitter 102b which has the advantage of linearly polarizing the input light and reflecting it by 90 degrees, thus coupling the light into transparent upper substrate 118b. Next, the light propagates through transparent upper electrode 116b and upper alignment layer 114b. The light then propagates through LC layer 112b, where the state of polarization may be changed and then passes through lower alignment layer 1110b. The light is then reflected off of a lower reflector. Typically, the lower reflector is implemented as reflective lower electrode 108b, made from a material such as aluminum. The light then propagates a second time through lower alignment layer 110b, LC layer 112b, upper alignment layer 114b, transparent upper electrode 116b, and transparent upper substrate 118b. The light then passes through polarizing beam splitter 102b a second time, which is now acting as the output analyser. Again, the viewer will see a bright or a dark display depending on whether a voltage is placed across LC layer 112b by the two electrodes, 108b and 116b.

For reflective displays, several of the fabrication requirements can be quite different compared to transmissive displays. The lower substrate, although it may be glass, may be a non-transmissive material such as a silicon wafer. The lower electrode no longer needs to be transparent, thus many different metals can be used. Since the light passes through LC layer 112b twice, it is important to note that even for displays described as TN or ECB, the actual LC cell construction must be different from an equivalent transparent display because of the effect of two passes through the LC layer on the polarization state of the light.

The choice of electrode material is determined by the design of the LCD device. For backlit transparent displays, both electrodes must be transmissive to visible light. An example of a suitable transparent electrode material is Indium-Tin-Oxide. When the display is operated in a reflective mode, lower electrode 2 can be a reflecting conductor such as aluminum or chrome, or a combination of materials such as alloys or multi-layer metal and dielectric structures.

It will be appreciated by those of skill in the art that many additional components may be added to the structure shown in FIG. 1(a) and (b), such as passivation layers, planarization layers, color filter layers, and other components, which may effect the fabrication and operation of the LCD device. However, the method of measuring the intrinsic DC offset potential that will result in the finished LCD device will apply equally to all such combinations of structures.

It has been discovered, herein, that the surface potential of the assembly of layers that contact the LC material is the controlling parameter for predicting intrinsic DC offset potential within a finished LCD device. Specifically, the DC offset potential that will exist in a finished LCD device can be predicted before the LCD device is finished by making non-contacting measurements of the surface potential of the upper and lower assemblies of the LCD device. The difference in surface potentials so measured, or surface potential difference, predicts the intrinsic DC offset potential that will exist in the finished LCD device.

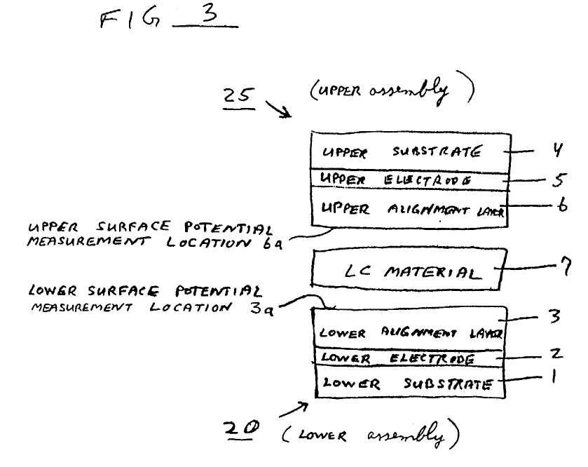

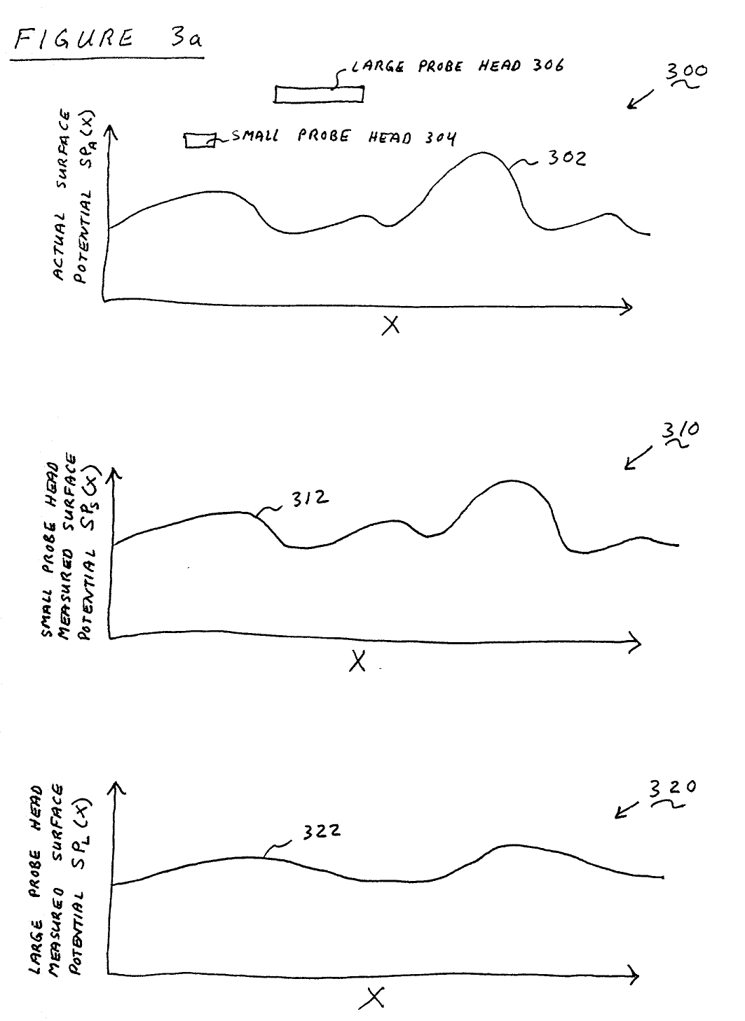

To determine the DC offset potential that will occur in a finished LCD device it is necessary to accurately measure the surface potential of the two complete assemblies just prior to assembly and filling with LC material 7. FIG. 3 indicates the upper and lower assemblies of an LCD and shows where the surface potentials of the assemblies are measured. With reference to FIG. 3, lower assembly 20 includes lower substrate 1, lower electrode 2, and lower alignment layer 3. The surface potential of lower assembly 20 is measured at measurement location 3a, which is the surface of lower alignment layer 3 that will make contact with LC material 7 in the finished LCD device. In a similar manner, upper assembly 25 includes upper substrate 4, upper electrode 5, and upper alignment layer 6. The surface potential of upper assembly 25 is measured at measurement location 6a, which is the surface of upper alignment layer 6 that will make contact with LC material 7 in the finished LCD device.

In practice, the surface potential is likely to vary over the surface of the upper or lower assembly. Therefore, it may be necessary to take several measurements of the surface potential and compute an average for an assembly.

Additionally, the accuracy of the measured surface potential of an assembly, as compared with the actual surface potential of an assembly, will vary according to the properties of the measurement system employed. FIG. 3a depicts the spatial filtering that occurs due to averaging, resulting from the probe head's width. With reference to FIG. 3a, actual surface potential distribution SP_{A}(x) 300 is shown for a possible surface to be measured. This surface distribution may be measured with small probe head 304 or large probe head 306. The result of measuring surface potential distribution 300 with small probe head 304 is shown in small probe head measured surface potential SP_{S}(x) 310 as curve 312. The result of measuring actual surface potential distribution 300 with large probe head 306 is shown in large probe head measured surface potential SP_{L}(x) 320 as curve 322.

Small probe head 304 filters actual surface potential distribution 300, curve 302, less than large probe head 306. Thus, a more accurate measurement of actual surface potential distribution 300 is obtained with small probe head 304. This phenomenon of averaging is applicable to measurement systems of this type and should be noted by those skilled in the art when attempting to measure the surface potential distribution of a surface. It should be noted that in order to obtain a more accurate measurement of the actual surface potential SP_{A}(x) 302, a point sensor would be required. However, in practice a suitable approximation may be achieved with a probe head whose width is chosen to be small enough relative to the fluctuations of the surface potential to be measured. Probe heads of decreasing size may be used until the measurements converge, thereby arriving at the proper probe head size.

As mentioned above, averaging measurements made at several points on a surface is usually sufficient to obtain the necessary reading of the surface potential.

In the case of large displays, where the pixel size and display size are large relative to the sampling size of the probe head, it is possible to measure individual pixels directly and average over several pixels, as described in the preceding paragraphs, to obtain an estimate of the DC offset for the display.

For the case of a display where the pixels are much smaller than the smallest practical probe head, but the active area of the display containing all the pixels is larger than the probe head, then one may make a measurement of several pixels thereby measuring the average surface potential of several pixels, including inter-pixel areas separating active pixels which may be fabricated with different materials than the pixIes and hence have a different surface potential, and use this measurement to estimate the DC offset of the display. In some instances, it may be necessary to compare the surface potential measurements with the actual DC offset measurements made on completed operating displays, and then re-scale the surface potential measurements to account for the influence of the inter-pixel areas.

Where both the size of the pixels, and the size of the active area itself is smaller than can be accurately measured with available probe heads, there may be areas around the periphery of the active area where a measurement of the surface potential would be representative of the surface potential of an actual pixel. In this case, measurements of this area of a layer would be used to estimate the DC offset potential.

Several display assemblies, each of which may be too small to be measured directly, and where there is no available area on the periphery of the individual displays to be measured, may be manufactured together on a larger substrate, such as the case of Liquid Crystal on Silicon based LCD displays in which several display active matrix assemblies are fabricated simultaneously on a single Silicon wafer. In this case, there may be areas on the periphery of the wafer, which are representative of the DC offset of the pixels, and can be used to estimate the DC offset of all the displays from the specific wafer.

Finally, it may be impossible to make a direct measurement on a pixel, display, or substrate, in which case it has been shown that it is possible to fabricate test structures, of a size suitable for measurements with an existing probe head, that are fabricated with the same materials and processes such that the surfaces measured give surface potential measurements that are equivalent to those that would be measured on a pixel, display or substrate if they were of the appropriate size.

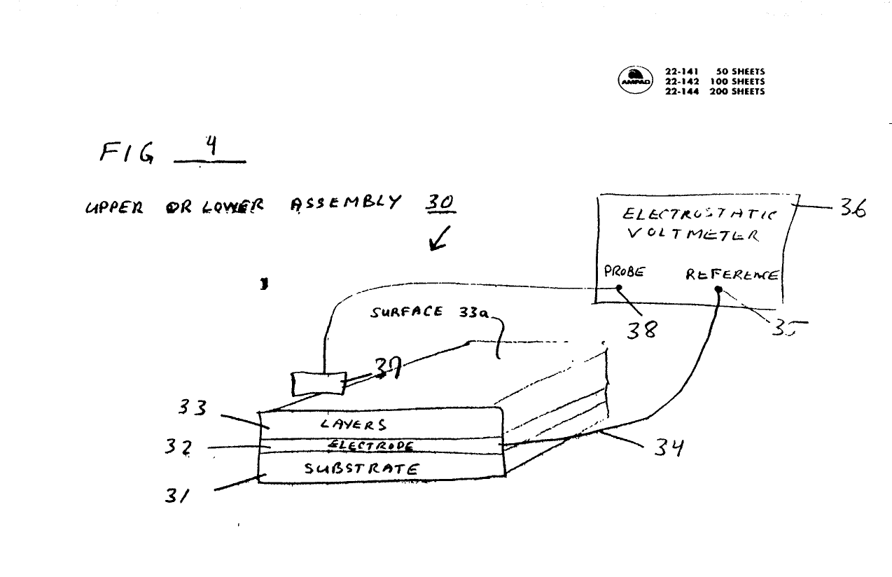

FIG. 4 depicts the configuration of the experimental test equipment used to predict the intrinsic DC offset potential in a LCD device. With reference to FIG. 4, LCD assembly 30 is shown ready for the surface potential measurement. LCD assembly 30 is either the lower or upper assembly that will be used to create the finished LCD device. Assembly 30 includes all the layers that will contact one side of LC material 7 (FIG. 3), such as substrate 31, electrode 32, and layers 33 (FIG. 4). An EFMD such as a non-contacting electrostatic voltmeter may be used to make the surface potential measurements. Reference connection 35 of electrostatic voltmeter 36 is connected to electrode 32 with lead 34. To ensure an accurate measurement, a good low resistance electrical contact should be made with electrode 32. If contact is made to layers 33 on top of electrode 32 the measurement may not be accurate. Probe head 37 is connected to probe connection 38 of electrostatic voltmeter 36. Probe head 37 is placed proximate to surface 33a. A preferred distance is in the range of 0.1-2.0 millimeters. Suitable distances depend on the characteristics of the specific measurement desired and the measurement instrument. This distance can be chosen on the basis of the accuracy and repeatability of the measurement, as well as the desire not to touch or otherwise damage the substrate prior to fabrication into the LCD device. The value of the measured surface potential is then recorded. The surface potential measurement is then made for the other assembly that will form the finished LCD device. The magnitude of the difference between the surface potential measurements for the upper and lower assemblies of the LCD device is the magnitude of the DC offset potential that will be present when the assemblies are assembled and filled with LC material. Because electrostatic voltmeter measurements typically vary with distance, it is important that both surfaces be measured at very nearly the same separation distance between probe head and surface.

Typical electrostatic voltmeters usually measure the surface potential of an assembly with reference to an internal standard, or to an external reference or a value selected by the user, and as such make a relative measurement. It is important that the user of such a device be aware of the implications of making such a relative measurement. For example, when calculating the difference in the surface potential of two assemblies, the relative value cancels out. Therefore, there is no implication of a relative measurement except that both assemblies must be made with respect to the same reference. However, when making a comparison of the absolute surface potential of difference assemblies, for instance when defining a potential as “positive” or “negative” it is important to take into account the measurement is with respect to a reference. For a typical electrostatic voltmeter, the internal standard, which is used as a reference, is specified as the surface potential of gold. A non-contacting electrostatic voltmeter such as the Model 320B manufactured by Trek Instruments, Inc. provides sensitive measurement of the electrostatic potential of surfaces in the typical range of interest for LCD devices (±10 volts).

The advantages of this test setup and technique are that an assessment of the intrinsic DC offset potential in a LC cell can be made prior to fabrication of the device. Because this method is non-contacting, it does not damage the substrate in any way that would prevent the fabrication or proper function of a working LCD device. Since the thickness of the LC gap, which is subsequently filled with LC material, is typically between 1 and 10 micrometers, it will be apparent to those of skill in the art that this method avoids contamination by particles that may be deposited by contact or other damage that might occur during other forms of testing. Such contamination or damage is undesirable.

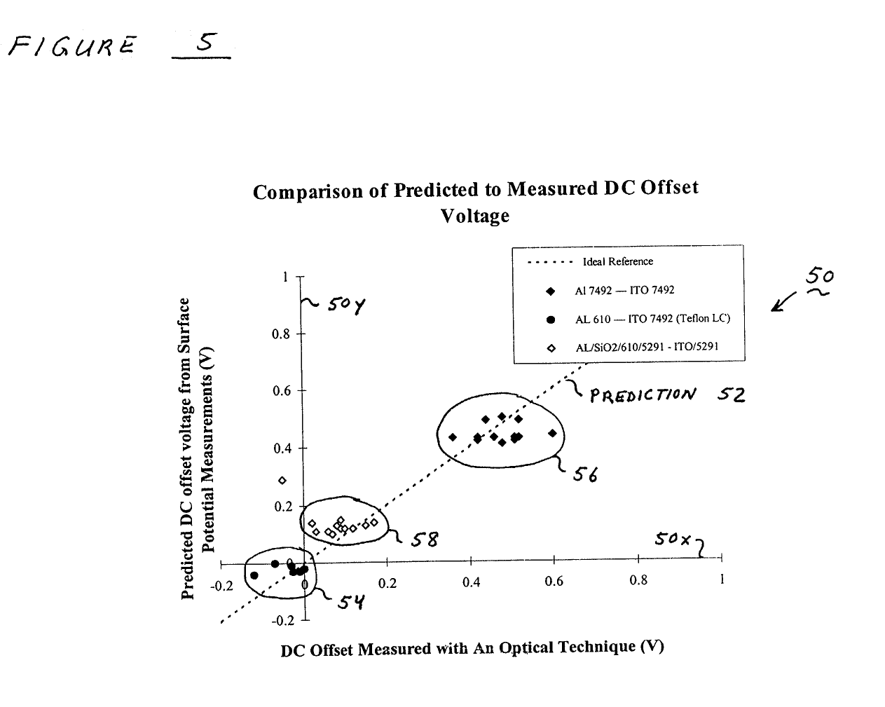

FIG. 5 is a plot of predicted DC offset potential, as measured with the disclosed methods and apparatus prior to LCD assembly, verses measured DC offset potential of the completed LCD device using optical measurement techniques for three different LCD devices. With reference to FIG. 5, comparison 50 plots predictions 52 of several displays for three specific LCD device designs. Predicted DC offset 50x, as predicted by the disclosed methods and apparatus, is plotted on the x-axis. Actual DC offset 50y, measured optically, is plotted on the y-axis. Prediction 52 results in points that lie on a line of slope 1 because by definition the measured DC offset and the predicted DC offset for the measured surface potentials should be the same value. Ideally, all measured points should lie on a slope of 1.

In the foregoing specification, the invention has been described with reference to specific embodiment thereof. It will be, however, evident that various modifications and changes may be made thereto without departing from the broader scope and spirit of the invention. The specification and drawings are, accordingly, to be regarded in an illustrative rather than restrictive sense.

What is claimed is:

1. A method of predicting an intrinsic DC offset potential in a liquid crystal display device, said method comprising:
connecting a terminal of an electric field measuring device to a first part of an upper liquid crystal display assembly;
placing a measurement probe of the electric field measuring device proximate to a surface of the upper liquid crystal display assembly that will contact a first surface of a liquid crystal layer of the liquid crystal display device when assembled;
measuring a surface potential of the surface of the upper liquid crystal display assembly with an electric field measuring device; and
repeating said connecting, placing, and measuring relative to a lower liquid crystal display assembly to obtain a surface potential measurement of the lower liquid crystal display assembly that will contact a second surface of the liquid crystal layer of the liquid crystal display device when assembled;
such that when the surface potential of the upper liquid crystal display assembly and the surface potential of the lower liquid crystal display assembly are mathematically combined, the prediction of the intrinsic DC offset potential is obtained.

2. The method of claim 1, wherein the electric field measuring device is non-contacting and wherein said surface potentials are mathematically combined by subtracting one surface potential from the others.

3. The method of claim 1, wherein the electric field measuring device is an electrostatic voltmeter.

4. The method of claim 3, wherein the electric field measuring device is non-contacting.

5. A method of predicting an intrinsic DC offset potential in a liquid crystal display device, said method comprising:
connecting reference terminals of two electric field measuring devices to electrodes from upper and lower liquid crystal display assemblies;
placing measurement probes of the electric field measuring devices proximate to surfaces of the liquid crystal display assemblies that will contact surfaces of a liquid crystal layer of the liquid crystal display device when assembled;
measuring surface potentials for the upper and lower assemblies with the electric field measuring devices; and
subtracting the surface potentials to obtain a prediction of the intrinsic DC offset potential.

6. The method of claim 5, wherein the electric field measuring devices are non-contacting.

7. The method of claim 5, wherein the electric field measuring devices are electrostatic voltmeters.

8. The method of claim 7, wherein the electric field measuring devices are non-contacting.

9. The method of claim 7, further comprising calibrating internal references of the electrostatic voltmeters.

10. An apparatus to predict an intrinsic DC offset potential, in a liquid crystal display device, said apparatus comprising:
an electric field measuring device;
a lower assembly of the liquid crystal display device; and
an upper assembly of the liquid crystal display device;
wherein a surface potential of said lower assembly and a surface potential of said upper assembly are measured with said electric field measuring device and subtracted, such that a prediction of the intrinsic DC offset potential is obtained.

11. The apparatus of claim 10, wherein said electric field measuring device is non-contacting.

12. The apparatus of claim 10, wherein said electric field measuring device is an electrostatic voltmeter.

13. The apparatus of claim 12, wherein the electric field measuring device is non-contacting

14. An apparatus to predict an intrinsic DC offset potential, in a liquid crystal display (LCD) device, said apparatus comprising:
an electric field measuring device having a reference connection and a probe;
a LCD lower assembly comprising a lower substrate in contact with a lower electrode in contact with a lower alignment layer, said lower alignment layer having an open surface, such that said LCD lower assembly is formed; and
a LCD upper assembly comprising an upper substrate in contact with an upper electrode in contact with an upper alignment layer, said upper alignment layer having an open surface, such that said upper LCD assembly is formed;
wherein said reference connection of said electric field measuring device is connected to said lower electrode and said probe is placed proximate to said open surface of said lower alignment layer so that a surface potential of said LCD lower assembly is measured, and said reference connection of said electric field measuring device is then connected to said upper electrode and said probe is placed proximate to said open surface of said upper alignment layer so that a surface potential of said LCD upper assembly is measured, the surface potential of the LCD lower assembly and the surface potential of the LCD upper assembly are subtracted to obtain a prediction of the intrinsic DC offset potential.

15. The apparatus of claim 14, wherein said electric field measuring device is non-contacting.

16. The apparatus of claim 14, wherein said electric field measuring device is an electrostatic voltmeter.

17. The apparatus of claim 16, wherein said electric field measuring device is on-contacting

18. An apparatus comprising:
means for connecting a reference terminal of an electric field measuring device to an electrode from an upper liquid crystal display assembly;
means for placing a measurement probe of the electric field measuring device proximate to a surface of the upper liquid crystal display assembly that will contact a first surface of a liquid crystal layer of a liquid crystal display device when assembled;
means for measuring a surface potential of the surface of the upper liquid crystal display assembly with the electric field measuring device; and
repeating said means for connecting, said means for placing, and said means for measuring to obtain a surface potential measurement of a lower liquid crystal display assembly that will contact a second surface of the liquid crystal layer of the liquid crystal display device when assembled;
such that when the surface potential of the upper liquid crystal display assembly and the surface potential of the lower liquid crystal display assembly are subtracted, a prediction of an intrinsic DC offset potential is obtained.

19. An apparatus comprising:
means for connecting reference terminals of two electric field measuring devices to electrodes from upper and lower liquid crystal display assemblies;
means for placing measurement probes of the electric field measuring devices proximate to surfaces of the liquid crystal display assemblies that will contact surfaces of a liquid crystal layer of a liquid crystal display device when assembled;
means for measuring surface potentials for the upper and lower liquid crystal display assemblies with the electric field measuring devices; and
means for subtracting the surface potentials to obtain a prediction of an intrinsic DC offset potential.
